(19) United States
(12) Patent Application Publication
(10) Pub. No.: US 2014/0024745 A1
(43) Pub. Date: Jan. 23, 2014

(54) TYRE, THE TREAD OF WHICH COMPRISES A POLY(ALKYLENE ESTER) RESIN

(71) Applicants: Didier Vasseur, Clermont-Ferrand Cedex 9 (FR); Olivia Cuscito, Clermont-Ferrand Cedex 9 (FR)

(72) Inventors: Didier Vasseur, Clermont-Ferrand Cedex 9 (FR); Olivia Cuscito, Clermont-Ferrand Cedex 9 (FR)

(73) Assignee: Compagnie Generale Des Etablissements Michelin, Clemont-Ferrand (FR)

(21) Appl. No.: 13/992,916

(22) PCT Filed: Dec. 19, 2011
(86) PCT No.: PCT/EP2011/073272

§ 371 Date: Sep. 3, 2013

(30) Foreign Application Priority Data
Dec. 23, 2010 (FR) 1061109

(51) Int. Cl. C08L 9/06; C08K 3/36; C08K 5/103

(52) U.S. Cl. CPC C08L 9/06; C08K 5/103; C08K 3/36
USPC 523/511; 523/526; 523/521

(57) ABSTRACT

A tyre, the tread of which comprises a rubber composition comprising at least: a diene elastomer; from 100 to 150 phr of a reinforcing inorganic filler; a poly(alkylene ester) thermoplastic resin; a plasticizing system comprising: according to a content A of between 5 and 60 phr, a hydrocarbon resin exhibiting a Tg of greater than 20° C.; according to a content B of between 5 and 60 phr, a plasticizer which is liquid at 20° C., the Tg of which is less than −20° C.; and it being understood that A+B is greater than 40 phr. The use of a poly(alkylene ester) resin, combined in particular with high contents of filler and plasticizers, makes it possible to improve the stiffness of the tread and thus the road behaviour of the tyre, without affecting the hysteresis and thus the rolling resistance.

The present invention relates to tyre treads and to rubber compositions based on a diene elastomer which can be used for the manufacture of such tyre treads.

A tyre tread has to respond, in a known way, to a large number of often conflicting technical requirements, including a high wear resistance, a low rolling resistance and a high dry and wet grip. It must also provide the tyre with good road behaviour.

These compromises in properties, in particular from the viewpoint of the rolling resistance and the wear resistance, could be improved in recent years with regard to energy-saving “Green Tyres”, intended in particular for passenger vehicles, by virtue in particular of the use of novel low-hysteresis rubber compositions having the characteristic of being reinforced predominantly by specific inorganic fillers, described as reinforcing fillers, in particular by highly dispersible silicas (HDSs), capable of rivalling, from the viewpoint of the reinforcing power, conventional tyre-grade carbon blacks.

It is known that, in order to improve the road behaviour, a greater stiffness of the tread or of the crown of the tyre is desirable. The increase in the stiffness can be obtained, for example, by increasing the content of reinforcing filler or by incorporating certain reinforcing resins in the constituent rubber compositions of this tread (see, for example, WO 02/10269), or by having available an elastomer underlayer between the belt and the external part of the tread of the tyre, exhibiting a greater stiffness than that of the said external part.

However, in a known way, such an increase in the stiffness of the tread can be damaging to the hysteresis properties and thus to the rolling resistance of the tyres.

During their research studies, the Applicant Companies have discovered a rubber composition which, used as tyre tread, makes it possible to improve the stiffness of the tread of the tyre and thus the road behaviour, without affecting the rolling resistance.

Thus, the invention relates to a tyre, the tread of which comprises a rubber composition comprising at least:
a diene elastomer;
from 100 to 150 phr of a reinforcing inorganic filler;
a poly(alkylene ester) thermoplastic resin;
a plasticizing system comprising:
   according to a content A of between 5 and 60 phr, a hydrocarbon resin exhibiting a Tg of greater than 20° C.;
   according to a content B of between 5 and 60 phr, a plasticizer which is liquid at 20° C., the Tg of which is less than −20° C.;
   it being understood that A+B is greater than 40 phr.

The tyres of the invention are intended in particular to equip motor vehicles of the passenger type, including 4×4 (four-wheel drive) vehicles and SUV vehicles (Sport Utility Vehicles), two-wheel vehicles (in particular motorcycles), and also industrial vehicles chosen especially from vans and heavy-duty vehicles, such as buses and heavy road transport vehicles, such as lorries.

The invention and its advantages will be readily understood in the light of the description and the implementational examples which follow.

### I—MEASUREMENTS AND TESTS USED

The rubber compositions used in the tyres according to the invention are characterized, after curing, as indicated below.

### I-1 Tensile Tests

These tests make it possible to determine the elasticity stresses and the properties at break. Unless otherwise indicated, they are carried out in accordance with French Standard NF T 46-002 of September 1988. The nominal secant moduli (or apparent stresses, in MPa) at 10% elongation (denoted EM10) are measured at the first elongation. All these tensile measurements are carried out under the standard conditions of temperature (23±2° C.) and hygrometry (50±5% relative humidity), according to French Standard NF T 40-101 (December 1979).

### I.2—Dynamic Properties

The dynamic properties are measured on a viscosity analyser (Metravib VA4000) according to Standard ASTM D 5992-96. The response is recorded of a sample of vulcanized composition (cylindrical test specimen with a thickness of 4 mm and a cross section of 400 mm²), subjected to a simple alternating sinusoidal shear stress, at a frequency of 10 Hz.

A strain amplitude sweep is carried out from 0.1% to 50% (outward cycle) and then from 50% to 1% (return cycle). The result made use of is the loss factor tan(δ). For the return cycle, the maximum value of tan(δ) observed, denoted by tan(δ)ₘₐₓ, at 23° C. is indicated.

It should be remembered that, in a way well-known to a person skilled in the art, the value of tan(δ)ₘₐₓ at 23° C. is representative of the hysteresis of the material and thus of the rolling resistance: the lower tan(δ)ₘₐₓ at 23° C., the lower the rolling resistance.

### II—DETAILED DESCRIPTION OF THE INVENTION

In the present description, unless expressly indicated otherwise, all the percentages (%) shown are percentages by weight.

The abbreviation “phr” means parts by weight per hundred parts of elastomer or rubber (of the total of the elastomers, if several elastomers are present).

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

All the values for glass transition temperature “Tg” are measured in a known manner by DSC (Differential Scanning calorimetry) according to Standard ASTM D3418 (1999).

The tyre of the invention thus has the essential characteristic that its tread comprises a rubber composition comprising at least a diene elastomer, a reinforcing inorganic filler, a specific plasticizing system and a poly(alkylene ester) resin, which components will be described in detail below.

### II.1—Diene Elastomer

It should be remembered here that elastomer (or “rubber”, the two terms being regarded as synonymous) of the “diene” type should be understood, in a known manner, to mean an (one or more is understood) elastomer resulting at least in part (i.e., a homopolymer or a copolymer) from diene monomers (monomers bearing two conjugated or non-conjugated carbon-carbon double bonds).

The diene elastomer is preferably selected from the group consisting of polybutadienes (BRs), synthetic polyisoprenes (IRs), natural rubber (NR), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be block, statistical, sequential or microsequential elastomers and can be prepared in dispersion or in solution; they can be coupled and/or star-branched or else functionalized with a coupling and/or star-branching or functionalization agent. Mention may be made, for example, for coupling to the reinforcing inorganic filler, such as silica, of silanol or polysiloxane functional groups having a silanol end (such as described, for example, in FR 2 740 778, U.S. Pat. No. 6,013,718 and WO 2008/141702), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909, U.S. Pat. No. 6,503,973, WO 2009/000750 and WO 2009/000752). Mention may also be made, as other examples of functionalized elastomers, of elastomers (such as SBR, BR, NR or IR) of the epoxidized type.

The following are suitable: polybutadienes and in particular those having a content (mol %) of 1,2-units of between 4% and 80% or those having a content (mol %) of cis-1,4-units of greater than 80%, polyisoprenes, butadiene/styrene copolymers and in particular those having a Tg (glass transition temperature (Tg, measured according to ASTM D3418) of between 0° C. and −70° C. and more particularly between −10° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%, butadiene/isoprene copolymers and especially those having an isoprene content of between 5% and 90% by weight and a Tg of −40° C. to −80° C., or isoprene/styrene copolymers and especially those having a styrene content of between 5% and 50% by weight and a Tg of between −5° C. and −50° C. In the case of butadiene/styrene/isoprene copolymers, those having a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2- plus 3,4-units of the isoprene part of between 5% and 70% and a content (mol %) of trans-1,4-units of the isoprene part of between 10% and 50%, and more generally any butadiene/styrene/isoprene copolymer having a Tg of between −5° C. and −70° C., are suitable in particular.

According to another specific embodiment, the diene elastomer is selected from the group consisting of polybutadienes, butadiene copolymers and the mixtures of these elastomers. More preferably, it is a styrene/butadiene copolymer (SBR).

According to a specific embodiment, the composition comprises from 5 to 100 phr of an SBR elastomer, whether an SBR prepared in emulsion (“ESBR”) or an SBR prepared in solution (“SSBR”).

According to other possible embodiments, the diene elastomer is an SBR/NR (or SBR/IR), BR/NR (or BR/IR) or also SBR/BR/NR (or SBR/BR/IR) blend.

In the case of an SBR (ESBR or SSBR) elastomer, use is made in particular of an SBR having a moderate styrene content, for example of between 20% and 35% by weight, or a high styrene content, for example from 35% to 45%, a content of vinyl bonds of the butadiene part of between 15% and 70%, a content (mol %) of trans-1,4-bonds of between 15% and 75% and a Tg of between −10° C. and −55° C.; such an SBR can advantageously be used as a mixture with a BR preferably having more than 90% (mol %) of cis-1,4-bonds.

According to another specific embodiment, the diene elastomer is an isoprene elastomer. “Isoprene elastomer” is understood to mean, in a known way, an isoprene homopolymer or copolymer, in other words a diene elastomer selected from the group consisting of natural rubber (NR), which may be plasticized or peptized, synthetic polyisoprenes (IRs), various isoprene copolymers and the mixtures of these elastomers. Mention will in particular be made, among isoprene copolymers, of isobutene/isoprene (butyl rubber—IIR), isoprene/styrene (SIR), isoprene/butadiene (BIR) or isoprene/butadiene/styrene (SBIR) copolymers. This isoprene elastomer is preferably natural rubber or a synthetic cis-1,4-polyisoprene; use is preferably made, among these synthetic polyisoprenes, of polyisoprenes having a content (mol %) of cis-1,4-bonds of greater than 90%, more preferably still of greater than 98%.

According to another preferred embodiment of the invention, the rubber composition comprises a blend of a (one or more) “high Tg” diene elastomer exhibiting a Tg of between −70° C. and 0° C. and of a (one or more) “low Tg” diene elastomer of between −110° C. and −80° C., more preferably between −105° C. and −90° C. The high Tg elastomer is preferably selected from the group consisting of S-SBRs, E-SBRs, natural rubber, synthetic polyisoprenes (exhibiting a content (mol %) of cis-1,4-enchainments preferably of greater than 95%), BIRs, SIRs, SBIRs, and the mixtures of these elastomers. The low Tg elastomer preferably comprises butadiene units according to a content (mol %) at least equal to 70%; it preferably consists of a polybutadiene (BR) exhibiting a content (mol %) of cis-1,4-enchainments of greater than 90%.

According to another specific embodiment of the invention, the rubber composition comprises, for example, between 30 and 90 phr, in particular between 40 and 90 phr, of a high Tg elastomer as a blend with a low Tg elastomer.

According to another specific embodiment of the invention, the diene elastomer of the composition according to the invention comprises a blend of a BR (as low Tg elastomer) exhibiting a content (mol %) of cis-1,4-enchainments of greater than 90% with one or more S-SBRs or E-SBRs (as high Tg elastomer(s)).

The compositions of the invention can comprise just one diene elastomer or a mixture of several diene elastomers.

### II.2—Poly(Alkylene Ester) Resin

The tread of the tyre according to the invention comprises a rubber composition which has the essential characteristic of comprising a poly(alkylene ester) resin which is, by definition, a polymer which is solid at ambient temperature (20° C.) and thermoplastic.

Preferably, this resin exhibits a glass transition temperature (Tg) of between −70° C. and 30° C., more preferably between −60° C. and 20° C. The melting point (measured by DSC) is preferably greater than 80° C., in particular between 80° C. and 150° C.

According to a preferred form, the ester of this resin is selected from the group consisting of adipates, succinates and their mixtures. These esters can optionally be combined with co-esters, such as, for example, carbonates or terephthalates.

According to another preferred embodiment, the alkylene of this resin is selected from the group consisting of methylene, ethylene, propylene and butylene. More preferably, the alkylene is butylene.

According to another embodiment of the invention, the poly(alkylene ester) resin is selected from the group consisting of poly(alkylene adipate)s, poly(alkylene succinate)s and their mixtures. Mention may in particular be made, as examples, of poly(butylene succinate adipate) (abbreviated to PBSA), poly(butylene succinate) (abbreviated to PBS) or poly(butylene adipate terephthalate) (abbreviated to PBAT).

Poly(alkylene ester) resins are well known as biodegradable plastics and are sold in particular for the packaging industry. Such products have also been described as rubber additives in rubber compositions for the tread of tyres having a low content of silica filler, for improving their rolling resistance property (see US2007/0032593 or EP 1 749 855).

These products are available commercially; for example poly(butylene succinate) is sold by Showa Highpolymer under the name “Bionolle 1001”, poly(butylene succinate adipate) is sold under the name “Bionolle 3001” by Showa Highpolymer and poly(butylene adipate terephthalate) is sold by BASF under the name “Ecoflex”.

The rubber composition preferably comprises more than 5 phr of poly(alkylene ester) resin, more preferably from 10 to 60 phr, in particular from 15 to 55 phr, for the purpose of optimising the stiffness and hysteresis properties as a function of the applications targeted.

### II.3—Reinforcing Filler

The composition of the tread of the tyre according to the invention comprises an inorganic reinforcing filler (such as silica) in a proportion of 100 to 150 phr, preferably of 105 to 145 phr.

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

Mineral fillers of the siliceous type, preferably silica (SiO₂), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g, in particular between 60 and 300 m²/g. Mention will be made, as highly dispersible precipitated silicas (“HDSs”), for example, of the Ultrasil 7000 and Ultrasil 7005 silicas from Degussa, the Zeosil 1165 MP, 1135 MP and 1115 MP silicas from Rhodia, the Hi-Sil EZ150G silica from PPG, the Zeopol 8715, 8745 and 8755 silicas from Huber or the silicas with a high specific surface as described in Application WO 03/16387. Mention will also be made, as reinforcing inorganic filler, of mineral fillers of the aluminous type, in particular alumina (Al₂O₃) or aluminium (oxide)hydroxides, or else reinforcing titanium oxides.

According to a preferred embodiment of the invention, the reinforcing inorganic filler comprises from 50% to 100% by weight of silica; in other words, the silica represents from 50% to 100% by weight of the reinforcing inorganic filler.

A person skilled in the art will understand that a reinforcing filler of another nature, in particular organic nature, such as carbon black, might be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer. Mention may be made, by way of example, for example, of carbon blacks for tyres, such as described, for example, in patent documents WO 96/37547 and WO 99/28380.

The content of reinforcing inorganic filler, in particular of silica, is preferably greater than 100 phr and less than 150 phr, more preferably within a range from 105 to 145 phr.

According to an advantageous embodiment, the composition of the tread can comprise carbon black. The carbon black, when it is present, is preferably used at a content of less than 20 phr, more preferably of less than 10 phr (for example between 0.5 and 20 phr, in particular between 2 and 10 phr). Within the intervals indicated, benefit is derived from the colouring properties (black pigmenting agent) and UV-stabilizing properties of the carbon blacks without, moreover, penalizing the performances introduced by the reinforcing inorganic filler.

In order to couple the reinforcing inorganic filler to the diene elastomer, use is made, in a well known way, of a coupling agent (or bonding agent) intended to provide a satisfactory connection, of chemical and/or physical nature, between the inorganic filler (surface of its particles) and the diene elastomer. This coupling agent is at least bifunctional. Use is made in particular of at least bifunctional organosilanes or polyorganosiloxanes.

Use is made in particular of silane polysulphides, referred to as “symmetrical” or “unsymmetrical” depending on their specific structure, such as described, for example, in Applications WO 03/002648 (or US 2005/016651) and WO 03/002649 (or US 2005/016650).

Particularly suitable, without the definition below being limiting, are silane polysulphides corresponding to the following general formula (I):

Z-A-Sₓ-A-Z, in which: (I)
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
the Z symbols, which are identical or different, correspond to one of the three formulae below:

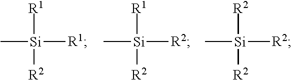

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
   the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferably still a group selected from C₁-C₄ alkoxyls, in particular methoxyl and ethoxyl).

In the case of a mixture of alkoxysilane polysulphides corresponding to the above formula (I), in particular normal commercially available mixtures, the mean value of the “x” indices is a fractional number preferably of between 2 and 5, more preferably of approximately 4. However, the invention can also advantageously be carried out, for example, with alkoxysilane disulphides (x=2).

Mention will more particularly be made, as examples of silane polysulphides, of bis((C₁-C₄)alkoxy(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl)polysulphides. Use is in particular made, among these compounds, of bis(3-triethoxysilylpropyl)tetrasulphide, abbreviated to TESPT, of formula [(C₂H₅O)₃Si(CH₂)₃S₂]₂, or bis(triethoxysilylpropyl)disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl)polysulphides (in particular disulphides, trisulphides or tetrasulphides), more particularly bis(monoethoxydimethylsilylpropyl)tetrasulphide, such as described in the abovementioned Patent Application WO 02/083782 (or U.S. Pat. No. 7,217,751).

Mention will in particular be made, as examples of coupling agents other than an alkoxysilane polysulphide, of bifunctional POSs (polyorganosiloxanes), or else of hydroxysilane polysulphides (R²=OH in the above formula I), such as described, for example, in Patent Applications WO 02/30939 (or U.S. Pat. No. 6,774,255), WO 02/31041 (or US 2004/051210) and WO2007/061550, or else of silanes or POSs bearing azodicarbonyl functional groups, such as described, for example, in Patent Applications WO 2006/125532, WO 2006/125533 and WO 2006/125534.

Mention will be made, as examples of other silane sulphides, for example, of the silanes bearing at least one thiol (—SH) functional group (referred to as mercaptosilanes) and/or at least one masked thiol functional group, such as described, for example, in Patents or Patent Applications U.S. Pat. No. 6,849,754, WO 99/09036, WO 2006/023815, WO 2007/098080, WO 2008/055986 and WO 2010/072685.

Of course, use might also be made of mixtures of the coupling agents described above, as described in particular in the abovementioned Application WO 2006/125534.

The content of coupling agent is preferably between 2 and 20 phr, more preferably between 3 and 15 phr.

### II.4—Plasticizing System

The composition of the tread of the tyre according to the invention has the other essential characteristic of comprising a plasticizing system comprising:
according to a content A of between 5 and 60 phr, a hydrocarbon resin exhibiting a Tg of greater than 20° C.;
according to a content B of between 5 and 60 phr, a plasticizer which is liquid at 20° C., the Tg of which is less than −20° C.;
it being understood that A+B is greater than 40 phr.

Preferably, the content of total plasticizing system A+B is within a range from 50 to 100 phr, more preferably from 50 to 80 phr.

The liquid plasticizer is liquid at 20° C.; it is described as a “low Tg” plasticizer, that is to say that it exhibits, by definition, a Tg of less than −20° C., preferably of less than −40° C.

Any extending oil, whether of aromatic or non-aromatic nature, any liquid plasticizing agent known for its plasticizing properties with regard to diene elastomers, can be used. At ambient temperature (20° C.), these plasticizers or these oils, which are more or less viscous, are liquids (that is to say, as a reminder, substances which have the ability to eventually assume the shape of their container), in contrast in particular to plasticizing hydrocarbon resins, which are by nature solids at ambient temperature.

Liquid plasticizing agents selected from the group consisting of liquid diene polymers, polyolefin oils, naphthenic oils, paraffinic oils, DAE (Distillate Aromatic Extracts) oils, MES (Medium Extracted Solvates) oils, TDAE (Treated Distillate Aromatic Extracts) oils, RAE (Residual Aromatic Extracts) oils, TRAE (Treated Residual Aromatic Extracts) oils, SRAE (Safety Residual Aromatic Extracts) oils, mineral oils, vegetable oils, ether plasticizers, ester plasticizers, phosphate plasticizers, sulphonate plasticizers and the mixtures of these compounds are particularly suitable. According to a more preferred embodiment, the liquid plasticizing agent is selected from the group consisting of MES oils, TDAE oils, naphthenic oils, vegetable oils and the mixtures of these oils.

According to a preferred embodiment of the invention, the liquid plasticizer, in particular petroleum oil, is of the non-aromatic type. A liquid plasticizer is described as non-aromatic when it exhibits a content of polycyclic aromatic compounds, determined with the extract in DMSO according to the IP 346 method, of less than 3% by weight, with respect to the total weight of the plasticizer. Therefore, use may preferably be made of a liquid plasticizing agent selected from the group consisting of MES oils, TDAE oils, naphthenic oils (of low or high viscosity, in particular hydrogenated or non-hydrogenated), paraffinic oils and the mixtures of these oils. RAE oils, TRAE oils and SRAE oils or the mixtures of these oils, which contain low contents of polycyclic compounds, are also suitable as petroleum oil.

According to another specific embodiment, the liquid plasticizer is a terpene derivative; mention may in particular be made, as example, of the product Dimarone from Yasuhara.

The liquid polymers resulting from the polymerization of olefins or dienes, such as, for example, those selected from the group consisting of polybutenes, polydienes, in particular polybutadienes, polyisoprenes, copolymers of butadiene and isoprene, copolymers of butadiene or isoprene and styrene, and the mixtures of these liquid polymers, are also suitable. The number-average molar mass of such liquid polymers is preferably within a range extending from 500 g/mol to 50 000 g/mol, more preferably from 1000 g/mol to 10 000 g/mol. Mention may in particular be made, by way of example, of the Ricon products from Sartomer.

According to another preferred embodiment of the invention, the liquid plasticizer is a vegetable oil. Use is preferably made of an oil selected from the group consisting of linseed, safflower, soybean, maize, cottonseed, rapeseed, castor, tung, pine, sunflower, palm, olive, coconut, peanut and grapeseed oils, and the mixtures of these oils, in particular a sunflower oil. This vegetable oil, in particular sunflower oil, is more preferably an oil rich in oleic acid, that is to say that the fatty acid (or all of the fatty acids, if several are present) from which it derives comprises oleic acid according to a fraction by weight at least equal to 60%, more preferably at least equal to 70%, in particular equal to or greater than 80%.

According to another specific embodiment of the invention, the liquid plasticizer is an ether; mention may be made, for example, of polyethylene glycols or polypropylene glycols.

The liquid plasticizers selected from the group consisting of ester plasticizers, phosphate plasticizers, sulphonate plasticizers and the mixtures of these compounds are also suitable. The triesters selected from the group consisting of triesters of carboxylic acid, of phosphoric acid or of sulphonic acid and the mixtures of these triesters are suitable in particular. Mention may in particular be made, as examples of carboxylic acid ester plasticizers, of the compounds selected from the group consisting of trimellitates, pyromellitates, phthalates, 1,2-cyclohexanedicarboxylates, adipates, azelates, sebacates, glycerol triesters and the mixtures of these compounds. Mention may in particular be made, among triesters, of glycerol triesters, preferably predominantly composed (for more than 50% by weight, more preferably for more than 80% by weight) of an unsaturated C₁₈ fatty acid, that is to say selected from the group consisting of oleic acid, linoleic acid, linolenic acid and the mixtures of these acids; more preferably, whether it is of synthetic or natural origin, the fatty acid used is composed, for more than 60% by weight, more preferably still for more than 70% by weight, of oleic acid; such triesters (trioleates) having a high content of oleic acid, of natural or synthetic origin, are well known; they have been described, for example, in Application WO 02/088238, as plasticizing agents in treads for tyres. Mention may be made, as phosphate plasticizers, for example, of those which comprise between 12 and 30 carbon atoms, for example trioctyl phosphate.

The hydrocarbon resin exhibits a Tg of greater than 20° C.

The designation “resin” is reserved in the present patent application, by definition, for a compound which is solid at ambient temperature (20° C.), in contrast in particular to a liquid plasticizing agent, such as an oil.

Hydrocarbon resins are polymers well known to a person skilled in the art, essentially based on carbon and hydrogen but being able to comprise other types of atoms, which can be used in particular as plasticizing agents or tackifying agents in polymer matrices. They are by nature miscible (i.e., compatible) at the contents used with the polymer compositions for which they are intended, so as to act as true diluents. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tyre rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic, based or not based on petroleum (if such is the case, also known under the name of petroleum resins). Their Tg is preferably greater than 30° C., in particular between 30° C. and 95° C.

In a known way, these hydrocarbon resins can also be described as thermoplastic resins in the sense that they soften when heated and can thus be moulded. They can also be defined by a softening point or temperature. The softening point of a hydrocarbon resin is generally greater by approximately 50 to 60° C. than its Tg value. The softening point is measured according to Standard ISO 4625 (Ring and Ball method). The macrostructure (Mw, Mn and PI) is determined by size exclusion chromatography (SEC) as indicated below.

As a reminder, the SEC analysis, for example, consists in separating the macromolecules in solution according to their size through columns filled with a porous gel; the molecules are separated according to their hydrodynamic volume, the bulkiest being eluted first. The sample to be analysed is simply dissolved beforehand in an appropriate solvent, tetrahydrofuran, at a concentration of 1 g/litre. The solution is then filtered through a filter with a porosity of 0.45 μm, before injection into the apparatus. The apparatus used is, for example, a “Waters Alliance” chromatographic line according to the following conditions: elution solvent: tetrahydrofuran; temperature 35° C.; concentration 1 g/litre; flow rate: 1 ml/min; volume injected: 100 μl; Moore calibration with polystyrene standards; set of 3 “Waters” columns in series (“Styragel HR4E”, “Styragel HR1” and “Styragel HR 0.5”); detection by differential refractometer (for example, “Waters 2410”) which can be equipped with operating software (for example, “Waters Milenium”).

A Moore calibration is carried out with a series of commercial polystyrene standards having a low PI (less than 1.2), with known molar masses, covering the range of masses to be analysed. The weight-average molar mass (Mw), the number-average molar mass (Mn) and the polydispersity index (PI=Mw/Mn) are deduced from the data recorded (curve of distribution by mass of the molar masses). All the values for molar masses shown in the present patent application are thus relative to calibration curves produced with polystyrene standards.

According to a preferred embodiment of the invention, the hydrocarbon resin exhibits at least any one, more preferably all, of the following characteristics:
a Tg of greater than 20° C. (in particular between 30° C. and 100° C.), more preferably of greater than 30° C. (in particular between 30° C. and 95° C.);
a softening point of greater than 50° C. (in particular between 50° C. and 150° C.);
a number-average molar mass (Mn) of between 400 and 2000 g/mol, preferably between 500 and 1500 g/mol;
a polydispersity index (PI) of less than 3, preferably of less than 2 (as a reminder: PI=Mw/Mn with Mw the weight-average molar mass).

Mention may be made, as examples of such hydrocarbon resins, of those selected from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins. Mention may more particularly be made, among the above copolymer resins, of those selected from the group consisting of (D)CPD/vinylaromatic copolymer resins, (D)CPD/terpene copolymer resins, terpene/phenol copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins.

The term “terpene” combines here, in a known way, α-pinene, β-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomers are, for example: styrene, α-methylstyrene, ortho-methylstyrene, meta-methylstyrene, para-methylstyrene, vinyltoluene, para(tert-butyl)styrene, methoxystyrenes, chloro styrenes, hydroxystyrenes, vinylmesitylene, divinylbenzene, vinylnaphthalene or any vinylaromatic monomer resulting from a C₉ fraction (or more generally a C₈ to C₁₀ fraction).

More particularly, mention may be made of the resins selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins and the mixtures of these resins.

All the above resins are well known to a person skilled in the art and are commercially available, for example sold by DRT under the name Dercolyte as regards polylimonene resins, sold by Neville Chemical Company under the name Super Nevtac, by Kolon under the name Hikorez or by Exxon Mobil under the name Escorez as regards C₅ fraction/styrene resins or C₅ fraction/C₉ fraction resins, or else by Struktol under the name 40 MS or 40 NS (mixtures of aromatic and/or aliphatic resins).

### II.5—Various Additives

The rubber compositions of the treads of the tyres in accordance with the invention also comprise all or a portion of the usual additives generally used in elastomer compositions intended for the manufacture of treads, such as, for example, pigments, protective agents, such as antiozone waxes, chemical antiozonants or antioxidants, antifatigue agents, reinforcing resins, methylene acceptors (for example phenolic novolak resin) or methylene donors (for example HMT or H3M), a crosslinking system based either on sulphur, or on sulphur donors and/or on peroxide and/or on bismaleimides, vulcanization accelerators or vulcanization activators.

These compositions can also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

### II.6—Preparation of the Rubber Compositions

The compositions used in the treads of the tyres of the invention can be manufactured in appropriate mixers, using two successive phases of preparation well known to a person skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) down to a lower temperature, typically of less than 110° C., for example between 40° C. and 100° C., during which finishing phase the crosslinking system is incorporated.

The process for preparing such compositions comprises, for example, the following stages:
thermomechanically kneading (for example in one or more goes) the diene elastomer or elastomers with the reinforcing inorganic filler, the coupling agent, if appropriate the carbon black, the plasticizing system and the poly(alkylene ester) resin, until a maximum temperature of between 110° C. and 190° C. is reached (“non-productive” phase);
cooling the combined mixture to a temperature of less than 100° C.;
subsequently incorporating, during a second stage (“productive” stage), a crosslinking system;
kneading everything up to a maximum temperature of less than 110° C.

By way of example, the non-productive phase is carried out in a single thermomechanical stage during which, in a first step, all the base constituents (the diene elastomer or elastomers, the plasticizing system, the reinforcing inorganic filler, the coupling agent and the poly(alkylene ester) resin) are introduced into an appropriate mixer, such as a standard internal mixer, followed, in a second step, for example after kneading for one to two minutes, by the other additives, optional additional agents for covering the filler or processing aids, with the exception of the crosslinking system. The total duration of the kneading, in this non-productive phase, is preferably between 1 and 15 min.

After cooling the mixture thus obtained, the crosslinking system is then incorporated in an external mixer, such as an open mill, maintained at a low temperature (for example between 40° C. and 100° C.). The combined mixture is then mixed (productive phase) for a few minutes, for example between 2 and 15 min

The crosslinking system proper is preferably based on sulphur and on a primary vulcanization accelerator, in particular on an accelerator of the sulphenamide type. Various known secondary vulcanization accelerators or vulcanization activators, such as zinc oxide, stearic acid, guanidine derivatives (in particular diphenylguanidine), and the like, come to be added to this vulcanization system, being incorporated during the first non-productive phase and/or during the productive phase. The sulphur content is preferably between 0.5 and 3.0 phr and the content of the primary accelerator is preferably between 0.5 and 5.0 phr.

Use may be made, as (primary or secondary) accelerator, of any compound capable of acting as accelerator of the vulcanization of diene elastomers in the presence of sulphur, in particular accelerators of the thiazole type and their derivatives and accelerators of the thiuram and zinc dithiocarbamate types. These accelerators are more preferably selected from the group consisting of 2-mercaptobenzothiazyl disulphide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-(tert-butyl)-2-benzothiazolesulphenamide (abbreviated to “TBBS”), N-(tert-butyl)-2-benzothiazolesulphenimide (abbreviated to “TBSI”), zinc dibenzyldithiocarbamate (abbreviated to “ZBEC”) and the mixtures of these compounds. Preferably, use is made of a primary accelerator of the sulphenamide type.

The final composition thus obtained can subsequently be calendered, for example in the form of a sheet or of a plaque, in particular for laboratory characterization, or also extruded, for example in order to form a rubber profiled element used in the manufacture of a tread.

The invention relates to the tyres described above, both in the uncured state (i.e., before curing) and in the cured state (i.e., after crosslinking or vulcanization).

### III—EXAMPLES OF THE IMPLEMENTATION OF THE INVENTION

### III.1—Preparation of the Compositions

The following tests are carried out in the following way: the diene elastomer, the reinforcing inorganic filler (silica), the plasticizing system and the poly(alkylene ester) resin, and also the various other ingredients, with the exception of the vulcanization system, are successively introduced into an internal mixer (final degree of filling: approximately 70% by volume), the initial vessel temperature of which is approximately 60° C. Thermomechanical working (non-productive phase) is then carried out in one stage, which lasts in total approximately from 3 to 4 min, until a maximum “dropping” temperature of 165° C. is reached.

The mixture thus obtained is recovered and cooled and then sulphur and an accelerator of sulphenamide type are incorporated on a mixer (homofinisher) at 30° C., everything being mixed (productive phase) for an appropriate time (for example between 5 and 12 min)

The compositions thus obtained are subsequently calendered, either in the form of plaques (thickness from 2 to 3 mm) or of thin sheets of rubber, for the measurement of their physical or mechanical properties, or extruded in the form of a tread.

### III.2—Tests

The tests which follow demonstrate the increase in the low-strain stiffness of the compositions of the treads of the tyres according to the invention, without affecting their hysteresis.

For this, seven rubber compositions for a tread were prepared as indicated above, six in accordance with the invention (hereinafter denoted C.2 to C.7) and one not in accordance with the invention (control composition, hereinafter denoted C.1).

Their formulations are presented in the appended Table 1.

Composition C.1 is a control composition, based on SBR, which can be used in treads of “Green Tyres” (having a low rolling resistance) for passenger vehicles. Compositions C.2 to C.7 are also based on SBR. All the compositions C.1 to C.7 furthermore comprise high contents of reinforcing inorganic filler and of plasticizing system. The plasticizing system comprises a hydrocarbon resin (C₅/C₉ resin) and a liquid plasticizer (mixture of sunflower oil, TDAE oil and MES oil).

Compositions C.2 to C.7 differ from the control composition C.1 only in the addition of a poly(alkylene ester) resin. In particular, C.2 and C.3 respectively comprise 10 and 40 phr of poly(butylene adipate terephthalate) (abbreviated to PBAT), C.4 and C.5 respectively comprise 10 and 40 phr of poly(butylene succinate) (abbreviated to PBS), and C.6 and C.7 respectively comprise 10 and 40 phr of poly(butylene succinate adipate) (abbreviated to PBSA).

The properties of the compositions after curing (vulcanization) have been summarized in the appended Table 2.

It is noted that compositions C.2 to C.7 exhibit a low-strain stiffness (EM10) which is always greater than that of the control composition, which is synonymous, to a person skilled in the art, with an improvement in the road behaviour of the tyres. The stiffness of the compositions is particularly increased for the compositions comprising more than 10 phr of poly(alkylene ester) resin (in this case, in the examples C.3, C.5 and C.7, 40 phr).

Furthermore, the hysteresis (represented by Tan(δ)ₘₐₓ at 23° C.) of compositions C.2 to C.7 remains identical to that of the control composition, which is a clear indicator, to a person skilled in the art, of a rolling resistance equivalent to that of the control composition.

In conclusion, the results of these tests demonstrate that the use of a poly(alkylene ester) resin, in particular in the presence of high contents of filler and plasticizers, makes it possible to obtain a rubber composition for a tyre tread which exhibits a greater low-strain stiffness, synonymous with an improvement in the road behaviour, while retaining an equivalent rolling resistance.

TABLE 1

| | Composition No. | | | | | | |
|---|---|---|---|---|---|---|---|
| | C.1 | C.2 | C.3 | C.4 | C.5 | C.6 | C.7 |
| SBR (1) | 100 | 100 | 100 | 100 | 100 | 100 | 100 |
| Inorganic filler (2) | 110 | 110 | 110 | 110 | 110 | 110 | 110 |
| Carbon black (3) | 4 | 4 | 4 | 4 | 4 | 4 | 4 |
| Silane (4) | 8.8 | 8.8 | 8.8 | 8.8 | 8.8 | 8.8 | 8.8 |
| Poly(alkylene ester) | — | 10 | 40 | — | — | — | — |
| (5) | | | | | | | |
| Poly(alkylene ester) | — | — | — | 10 | 40 | — | — |
| (6) | | | | | | | |
| Poly(alkylene ester) | — | — | — | — | — | 10 | 40 |
| (7) | | | | | | | |
| Liquid plasticizer (8) | 33 | 33 | 33 | 33 | 33 | 33 | 33 |
| Resin (9) | 22 | 22 | 22 | 22 | 22 | 22 | 22 |
| Antioxidant (10) | 1.5 | 1.5 | 1.5 | 1.5 | 1.5 | 1.5 | 1.5 |
| DPG (11) | 2 | 2 | 2 | 2 | 2 | 2 | 2 |
| ZnO (12) | 1.8 | 1.8 | 1.8 | 1.8 | 1.8 | 1.8 | 1.8 |
| Stearic acid (13) | 2 | 2 | 2 | 2 | 2 | 2 | 2 |
| CBS (14) | 2 | 2 | 2 | 2 | 2 | 2 | 2 |
| Sulphur | 1.3 | 1.3 | 1.3 | 1.3 | 1.3 | 1.3 | 1.3 |

(1) Solution SBR (contents expressed as dry SBR) with 40% of styrene and 12% of 1,2-butadiene units (Tg = −28° C.);
(2) Silica (Ultrasil 7000 GR from Degussa);
(3) Carbon black N234;
(4) Silane TESPT (Si69 from Degussa);
(5) PBAT: poly(butylene adipate/terephthalate) (Ecoflex F BX 7011 from BASF);
(6) PBS: poly(butylene succinate) (Bionolle 1001 from Showa Highpolymer);
(7) PBSA: poly(butylene succinate adipate) (Bionolle 3001 from Showa Highpolymer);
(8) Mixture of sunflower vegetable oil (Lubrirob Tod 1880 from Novance), of TDAE (Vivatec 500 from Klaus Dahleke) and of MES extending oil for SBR (Catenex SNR from Shell);
(9) C₅/C₉ resin (Escorez ECR-373 from Exxon);
(10) N-(1,3-Dimethylbutyl)-N-phenyl-para-phenylenediamine (Santoflex 6-PPD from Flexsys);
(11) DPG = Diphenylguanidine (Perkacit DPG from Flexsys);
(12) Zinc oxide (industrial grade—Umicore);
(13) Stearin (Pristerene from Uniqema);
(14) N-Cyclohexyl-2-benzothiazolesulphenamide (Santocure CBS from Flexsys).

TABLE 2

| | Composition No. | | | | | | |
|---|---|---|---|---|---|---|---|
| | C.1 | C.2 | C.3 | C.4 | C.5 | C.6 | C.7 |
| EM10 | 5.0 | 5.5 | 7.5 | 6.0 | 7.8 | 5.8 | 6.7 |
| Tan(δ)ₘₐₓ at 23° C. | 0.31 | 0.31 | 0.31 | 0.31 | 0.31 | 0.31 | 0.31 |

1. A tire, the tread of which comprises a rubber composition comprising at least:
a diene elastomer;
from 100 to 150 phr of a reinforcing inorganic filler;
a poly(alkylene ester) thermoplastic resin;
a plasticizing system comprising:
according to a content A of between 5 and 60 phr, a hydrocarbon resin exhibiting a Tg of greater than 20° C.;
according to a content B of between 5 and 60 phr, a plasticizer which is liquid at 20° C., the Tg of which is less than −20° C.;
wherein A+B is greater than 40 phr.

2. The tire according to claim 1, wherein the diene elastomer is selected from the group consisting of polybutadienes (BRs), synthetic polyisoprenes (IRs), natural rubber (NR), butadiene copolymers, isoprene copolymers and mixtures of these elastomers.

3. The tire according to claim 2, wherein the diene elastomer is selected from the group consisting of polybutadienes, butadiene copolymers and the mixtures of these elastomers.

4. The tire according to claim 3, wherein the diene elastomer is a styrene/butadiene copolymer (SBR).

5. The tire according to claim 4, wherein the SBR content is within a range from 50 to 100 phr.

6. The tire according to claim 1, wherein the content of poly(alkylene ester) resin is greater than 5 phr.

7. The tire according to claim 1, wherein the ester of the poly(alkylene ester) resin is selected from the group consisting of adipates, succinates and their mixtures.

8. The tire according to claim 1, wherein the alkylene of the poly(alkylene ester) resin is selected from the group consisting of methylene, ethylene, propylene, butylene and their mixtures.

9. The tire according to claim 8, wherein the alkylene of the poly(alkylene ester) resin is a butylene.

10. The tire according to claim 1, wherein the poly(alkylene ester) resin is selected from the group consisting of poly(alkylene adipate)s, poly(alkylene succinate)s and their mixtures.

11. The tire according to claim 1, wherein A+B is within a range from 50 to 100 phr.

12. The tire according to claim 1, wherein the hydrocarbon resin is selected from the group consisting of cyclopentadiene homopolymer or copolymer resins, dicyclopentadiene homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins.

13. The tire according to claim 1, wherein the liquid plasticizer is selected from the group consisting of liquid diene polymers, polyolefin oils, naphthenic oils, paraffinic oils, DAE oils, MES oils, TDAE oils, RAE oils, TRAE oils, SRAE oils, mineral oils, vegetable oils, ether plasticizers, ester plasticizers, phosphate plasticizers, sulphonate plasticizers and the mixtures of these compounds.

14. The tire according to claim 13, wherein the liquid plasticizer is selected from the group consisting of MES oils, TDAE oils, naphthenic oils, vegetable oils and the mixtures of these oils.

15. The tire according to claim 1, wherein the reinforcing inorganic filler comprises silica.

16. The tire according to claim 6, wherein the content of poly(alkylene ester) is within a range from 10 to 60 phr.
